(19) United States
(12) Patent Application Publication
(10) Pub. No.: US 2002/0000810 A1
(43) Pub. Date: Jan. 3, 2002

(54) DEVICE FOR MEASURING THE STATE VARIABLE OF PARTICLES

(76) Inventors: WALTER BAUER, EBERDINGEN (DE); HANS BRAUN, STUTTGART (DE)

Correspondence Address: STRIKER STRIKER & STENBY, 103 EAST NECK ROAD, HUNTINGTON, NY, 11743

(21) Appl. No.: 09/117,321

(22) PCT Filed: Oct. 16, 1997
(86) PCT No.: PCT/DE97/02380

(30) Foreign Application Priority Data
Dec. 12, 1996 (DE) 196 51 611.0

(51) Int. Cl. G01N 27/62

(52) U.S. Cl. 324/464

(57) ABSTRACT

A device for contactless measurement of a particle state variable of a flowing medium that contains electrically charged particles is disclosed, in which a sheet-like sensor element is disposed parallel to the particle flight direction, or at least two sensor elements, such as electrodes, are disposed in succession in the flow direction. At these electrodes, by means of the electrically charged particles flying past, charges are influenced, from which voltage signals can be generated with the aid of suitable amplifiers. To determine the particle concentration, the voltage alternation component is evaluated; to determine the particle velocity, the transport time τ is evaluated; and to determine the particle throughput, both the signal height and the chronological displacement of the individual signals from one another are evaluated.

The invention relates to a device for measuring a particle state variable of a flowing medium that contains electrically charged particles, as generically defined by the preamble to the coordinate claims. The particle state variable is either the pd or the particle velocity or the particle throughput.

### PRIOR ART

In measuring a volumetric flow of a moving medium, it is known to use at least two sensors, which are located in succession in terms of the flow direction of the flowing medium. The output signals of these sensors are converted, with the aid of an evaluation device, into electrical signals which are then compared with one another.

From German Patent 36 27 162, one such arrangement for contactless measurement of the volumetric flow of a moving medium is known, in which two converters are used whose output signals are evaluated with the aid of a cross-correlation function. The value for the volumetric flow of the moving medium is determined from the increase in the chronological cross-correlation function of the two signals, for a chronological displacement of zero, or from the first moment of the cross-performance density spectrum of the two signals. In an expansion of this known arrangement, a plurality of converters are disposed along the direction of motion of the moving medium, with the detection ranges of the converter elements overlapping. A transmitter-receiver unit is for instance used as the converter. The transmitter generates a field to be influenced by the nonhomogeneities of the medium. An associated receiver responds to the field influenced by the nonhomogeneities and outputs an electrical signal that replicates the changes over time in the field. Optical, acoustical or capacitive systems may be employed as the converter or receiver. Inflowing media whose nonhomogeneities are active and which themselves generate a usable field, examples being media that contain radioactive particles, work can be done without a transmitter; in that case, the radiation of the radioactive particles is received in the receiver and converted into an electrical signal.

From U.S. Pat. No. 3,744,461, an arrangement for measuring the smoke density in the exhaust gas system of an internal combustion engine is known, in which the pd of the electrically charged particles is ascertained with the aid of an electrode array. The electrodes face one another and are charged by the charged smoke particles. The density of the flowing smoke particles can be ascertained by measuring the potential of the electrodes.

### ADVANTAGES OF THE INVENTION

The device according to the invention for measuring a particle state variable, having the characteristics of claim 1, has the advantage over the known systems that a measurement array is simple and yet sensitive. Since the electrode of the measurement array is kept to ground potential, there are advantages in signal evaluation. A leakage resistance of the electrodes toward ground, caused by soot deposition, affects the mode of operation not at all, or only very slightly, because the electrodes are connected to ground.

These advantages are attained by a device having the characteristics of claim 1, in which for contactless measurement of the particle concentration of a flowing medium containing electrically charged particles, at least one sheetlike electrode is arranged in the particle flow in such a way that the charged particles do not strike the electrode and as they move past they influence electrical charges. These influenced charges cause an electrical alternating component in the output signal of the sensor, which acts as a measure of the particle concentration.

The device according to the invention as defined by the characteristics of claim 2 has the advantage that the particle velocity can be ascertained simply, and the device according to the invention as defined by the characteristics of claim 3 has the further advantage that the particle throughput can be ascertained with it as well.

These advantages are attained in that, in a device with the for contactless measurement of a particle state variable of a flowing medium containing electrically charged particles, two electrodes are disposed in succession in the flow direction, and the electrical output signals generated by influence on the electrodes are put in relation to one another. Since both the statistical similarity of the two output signals and their chronological displacement, which depend on the transport time of the particles from the first electrode to the second, are evaluated, an especially advantageous signal evaluation can be achieved. Further advantages of the invention are attained with the aid of the provisions recited in the other dependent claims.

### DRAWING

One exemplary embodiment of the invention is shown in the drawing and will be described in further detail in the ensuing description.

### DESCRIPTION

The drawing shows one exemplary embodiment of the invention, having two electrodes; with this device, particle emissions in the exhaust gas, for instance of a Diesel engine, can be ascertained.

To that end, at least two electrodes 11, 12, of sheetlike embodiment, for instance, are mounted in a pipe 10, for instance the exhaust system of the Diesel engine. These two electrodes 11, 12 are disposed in succession in the flow direction, designated by the letter V, and the surfaces are located approximately parallel to the disturbance or flight direction of the electrically charged particles. The electrodes 11, 12 may be in conductive communication with the exhaust system 10, and like the exhaust system, because of the amplifiers used, they are at ground potential.

The particles 13 located in the exhaust gas are electrostatically charged and therefore as they fly past the electrodes 11, 12 they influence a charge displacement. This charge displacement is transformed by the charge amplifiers 14, 15, associated with the electrodes, into voltage signals S1, S2. The charge amplifiers 14, 15 may be constructed as operational amplifiers OP1 and OP2, each with capacitors C1, C2 located in the feedback branch. The amplifiers keep the electrodes at ground potential.

The voltage signals output by the charge amplifiers OP1, OP2 are dependent on the charge density of the electrically charged particles 13. Each noise voltage obtained thus increases with the particle concentration and the particle charge. The signal courses established at the output of the charge amplifiers 14, 15 are plotted in the form of signals S1(t) and S2(t) over the time t. It can be scent at these signals have a certain correlation with one another. Because of the direction of motion from electrode 11 to electrode 12, the signals S1(t) and S2(t) are displaced relative to one another chronologically by the transport time τ. That is, the transport time τ is the time required by the particles to move from the electrode 11 to the electrode 12.

In an evaluation device 16, for instance controlled by microprocessor, the signals S1(t) and S2(t) are both subjected to a statistical evaluation and evaluated with regard to their chronological displacement from one another; depending on the type of evaluation, the concentration of the electrically charged particles, the particle velocity, or the particle throughput can be ascertained, the particle throughput being ascertained by multiplying the particle concentration and the particle velocity. The statistical evaluation of the individual signals leads to a measure of the extent to which the flow of exhaust gas is laden with electrically charged particles, such as soot particles. By evaluating the statistical similarities (correlations) of two signals that originate at different electrodes and are chronologically displaced from one another by the transport time τ of the particles, it is also possible to obtain a measure of the flow velocity of the exhaust gas flow. To that end, the transport time τ is calculated, which can be done for instance by evaluating the cross-correlation function of the two signals. In summary, both the signal height of the two signals and their chronological displacement from one another are evaluated in order to determine the particle throughput.

If further electrodes are periodically disposed in succession in the flow direction, and the associated signals are linked in a suitable way by addition and subtraction to a total signal, then electrically charged particles that fly past the electrode structure generate periodic components in the total signal. The frequency of the periodic components is proportional to the particle velocity. The determination of the frequency or the mean frequency can be used as a measure of the flow velocity. Determining this frequency can be done for instance by spectral analysis of the signals or by a suitable choice of the linkage plan of the electrode signals with the total signal, at little expenditure in terms of time.

If the described device for contactless measurement of the particle concentration is used in the exhaust system of a Diesel engine, then a variable can be obtained which represents a measure of the soot emitted by the engine. This variable can be used as a controlled variable or as an additional measurement variable in operation of the Diesel engine for regulating the injection system. However, the invention is not limited to measuring soot in Diesel engines and instead can be used generally to detect moving electrically charged particles.

If in a simplified embodiment only one electrode is used, then from the analysis of the signal course, particularly of the alternating component of the signal, the concentration of the charged particles can be ascertained, for instance by forming the variance. To form the variance, the signal is squared and low-pass filtered. This signal processing can be done in the evaluation device 16, which in that case must have suitable means available.

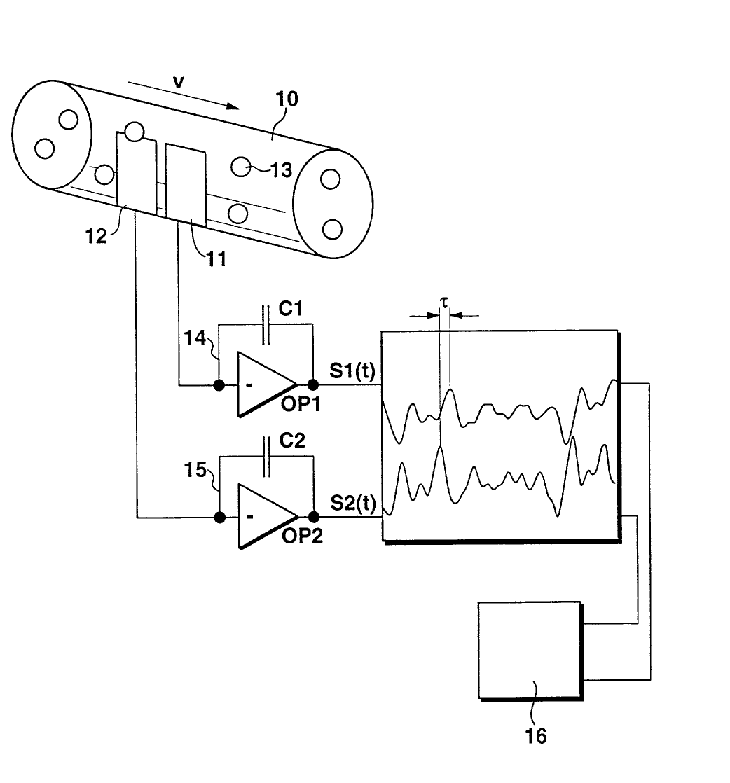

Forming the variants can naturally also be done in an application in accordance with FIG. 1; in that case at least one of the two signals S1(t) or S2(t) can be processed.

If only the flight time or the transport time τ is evaluated, then the velocity of the particles can still be ascertained. Calculating the transport time can be done for instance by forming a cross-correlation function.

1. A device for contactless measurement of a particle state variable of a medium flowing in a pipe and containing electrically charged particles, having at least one sensor element which furnishes electrical output signals that depend on the composition of the flowing medium, characterized in that the sensor element is a sheetlike electrode which is located substantially parallel to the particle flight direction and is kept at pipe potential, and alternating charge displacements are influenced by the electrically charged particles moving past, which displacements cause a signal change component in the electrical output signal, which component is evaluated as a measure of the particle concentration.

2. A device for contactless measurement of a particle state variable of a medium flowing in a pipe and containing electrically charged particles, having at least one sensor element which furnishes electrical output signals that depend on the composition of the flowing medium, characterized in that at least two sensor elements are embodied as sheetlike electrodes which are located substantially parallel to the particle flight direction and are disposed in succession in the disturbance direction and are kept at pipe potential, and alternating charge displacements are influenced by the electrically charged particles moving past, which displacements cause a signal change component in the electrical output signals, and the time lag r of the output signals relative to one another is evaluated as a measure of the particle velocity.

3. The device for contactless measurement of a particle state variable of claim 2, characterized in that in addition, the signal alternation components in the electrical output signals are evaluated as a measure of the particle concentration, and a measure of the particle throughput is also ascertained, from the product of the particle concentration and the particle velocity.

4. The device for contactless measurement of a particle state variable of claim 1 or 3, characterized in that the evaluation of the signal alternation components for determining the particle concentration is effected by ascertaining their variance.

5. The device for contactless measurement of a particle state variable of claim 4, characterized in that the variance is ascertained by squaring the signals and by subsequent low-pass filtration.

6. The device for contactless measurement of a particle state variable of one of the foregoing claims, characterized in that each electrode is assigned an amplifier with at least one operational amplifier and one feedback capacitor.

7. The device for contactless measurement of a particle state variable of one of the foregoing claims, characterized in that further electrodes are disposed in succession periodically in the flow direction, and their output signals are likewise amplified by means of associated charge amplifiers.

8. The device for contactless measurement of a particle state variable of one of the foregoing claims, characterized in that the frequency of the periodic component is ascertained; that from this the mean frequency is determined, and this mean frequency is evaluated as a measure of the flow velocity of the electrically charged particles, and the evaluation is effected by means of spectral analysis of the signals.

9. The device for contactless measurement of a particle state variable of one of the foregoing claims, characterized in that the evaluation of the individual signals is effected by a suitable choice of the linkage plan of the individual signals relative to the total signal and proceeds in the time range.

10. The device for contactless measurement of a particle state variable of one of the foregoing claims, characterized in that the sensor elements or electrodes are disposed in the exhaust system of an internal combustion engine and are used to ascertain the charged exhaust gas particles.

11. The device for contactless measurement of a particle state variable of claim 7, characterized in that the internal combustion engine is a Diesel engine, and the concentration of the soot particles contained in the exhaust gas is ascertained.
